(19) United States
(12) Patent Application Publication
(10) Pub. No.: US 2002/0178307 A1
(43) Pub. Date: Nov. 28, 2002

(54) Multiple memory card adapter

(76) Inventors: Khein Seng Pua, Chutung (TW); Jiu Jeng Liang, Chutung (TW)

Correspondence Address: RABIN & BERDO, P.C., 1101 14TH STREET, N.W., SUITE 500, WASHINGTON, DC, 20005, US

(21) Appl. No.: 09/864,401

(22) Filed: May 25, 2001

(51) Int. Cl. G06F 13/00

(52) U.S. Cl. 710/62; 710/301

(57) ABSTRACT

The invention provides a multiple memory card adapter that comprises an interface or connector for various types of memory cards. By utilizing the adapter of the present invention, only one adapter is needed in order to allow different type of memory cards to be read from or written to, by a host computer. This eliminates the need for plugging in or unplugging a dedicated adapter every time a different type of memory card is used.

### BACKGROUND OF THE INVENTION

1. Field of Invention

The present invention relates to a memory card adapter, and more particularly, to a memory card adapter that allows multiple memory cards of different types to be read from and written to by a host computer.

2. Description of Related Art

Memory cards are becoming an important means for storing data in a portable device. Devices such as digital cameras and portable digital audio players utilize memory cards to store pictures or music in a convenient and compact manner.

However, in order to read the data, such as digital images, that have been stored on the memory card, either the portable device must be connected to a host computer or a dedicated adapter for the particular memory card must be used.

Having to connect the portable device to a host computer in order to read the data usually requires plugging in and unplugging the device whenever the data on the memory card needs to be accessed. This can be very inconvenient and time consuming.

Another method is to utilize a dedicated adapter for the particular type of memory card that is being used. However, since different types of memory cards are used by different types of devices, having to purchase an additional adapter for each type of I memory card can be expensive. Additionally, each of the adapters must be plugged in and unplugged whenever the data on the particular type of memory card is accessed.

Therefore, a need exists for an improved system that eliminates the need for a dedicated memory card reader for each type of memory card used.

### SUMMARY OF THE INVENTION

To achieve these and other advantages and in order to overcome the disadvantages of the conventional memory card reader and in accordance with the purpose of the invention as embodied and broadly described herein, the present invention provides an improved memory card adapter that allows multiple memory cards of different types to be read from and written to by a host computer.

Various types of memory cards have been developed such as compact flash, smart media, memory stick, secure digital, and micro drive. Many of these cards have unique connectors or interfaces that do not allow them to be connected directly to an interface of a different type of memory card.

The present invention provides an adapter that comprises an interface or connector for each type of memory card. By utilizing the adapter of the present invention, only one adapter is needed in order to allow different types of memory cards to be read from or written to by a host computer. This eliminates the need for plugging in or unplugging a dedicated adapter every time a different type of memory card is used.

Also, by utilizing a high-speed bus interface such as, for example, a universal serial bus (USB) interface or a 1394 or firewire interface, data can be written to or read from the memory card by the host computer at high speeds.

In order to utilize the multiple memory card adapter, it must be connected to a host computer. A memory card is inserted into the appropriate connector on the multiple memory card adapter. The memory card is automatically recognized by type of card and size of memory.

After recognition, the host computer is able to write data to or read data from the memory card.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram of the multi-card adapter according to an embodiment of the present invention;

FIG. 2 is a diagram of the card sensor circuitry of the multi-card adapter according to an embodiment of the present invention;

FIG. 3 is a flowchart of the card detecting method of the multi-card adapter according to an embodiment of the present invention; and

FIG. 4 is a flowchart of the card recognition of the multi-card adapter according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

Therefore, the present invention provides an improved memory card adapter that allows multiple memory cards of different types to be read from and written to by a host computer.

Various types of memory cards have been developed such as compact flash, smart media, memory stick, secure digital, and micro drive. Many of these cards have unique connectors or interfaces that do not allow them to be connected directly to an interface of a different type of memory card.

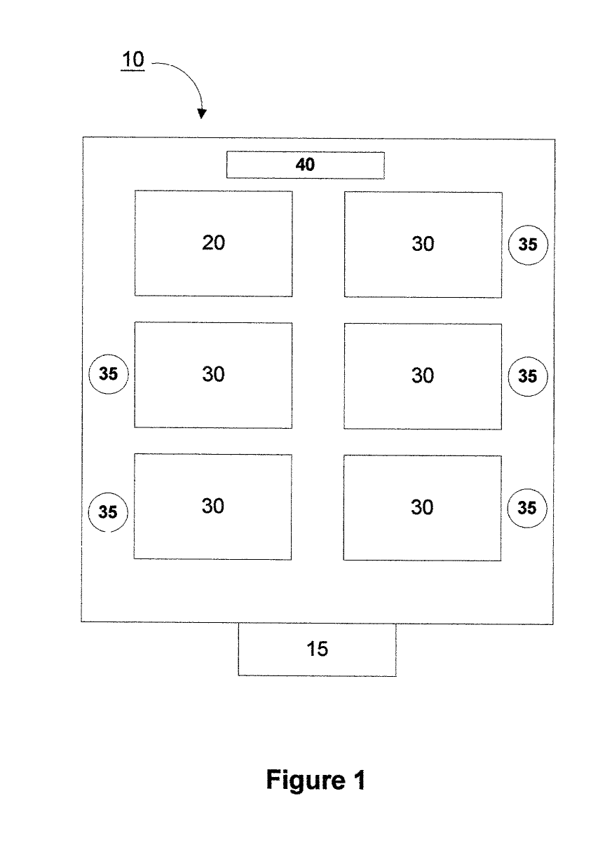

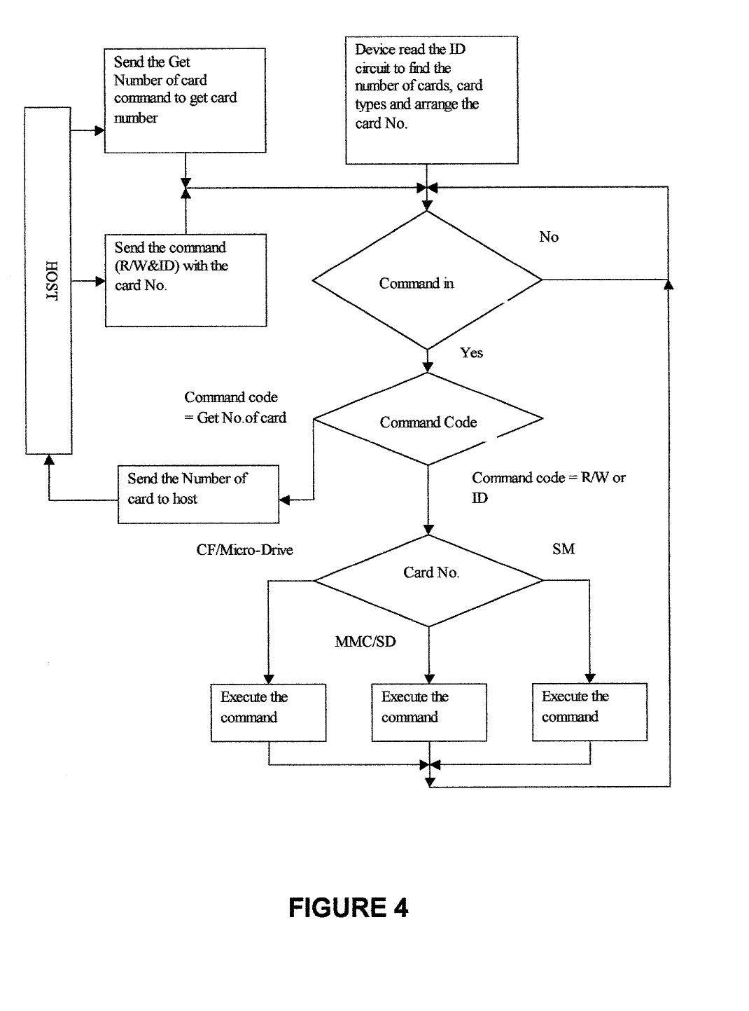

Refer to FIG. 1, which is a block diagram of the multi-card adapter according to an embodiment of the present invention and FIG. 4, which is a flowchart of the card recognition of the multi-card adapter according to an embodiment of the present invention.

The present invention provides a multiple memory card adapter 10 that comprises an interface or connector 30 for each type of memory card. By utilizing the multiple memory card adapter 10 of the present invention, only one adapter is needed in order to allow different types of memory cards to be read from or written to by a host computer. This eliminates the need for plugging in or unplugging a dedicated adapter every time a different type of memory card is used.

Also, by utilizing a high-speed bus interface such as, for example, a universal serial bus (USB) interface or a 1394 or firewire interface, data can be written to or read from the memory card by the host computer at high speeds. The multiple memory card adapter 10 connects to the high-speed bus via a connector 15.

In order to utilize the multiple memory card adapter 10, it must be connected to a host computer. A memory card is inserted into the appropriate connector 30 on the multiple memory card adapter 10. The memory card is automatically recognized by type of card and size of memory.

After recognition, the host computer is able to write data to or read data from the -memory card.

The multiple memory card adapter 10 comprises a high-speed bus and memory card control interface 20.

The high-speed bus and memory card control interface 20 further comprises a microprocessor which is a major part of the controller. The microprocessor reads the USB command and parameters and executes the corresponding command with parameter. It also manages and maps the USB FIFO address to a controller buffer while receiving data from or transferring data to the host computer. The microprocessor also manages the erase/program/read commands and addresses for the memory cards. Microprocessor ROM stores the program code of the controller and is built into the controller to reduce the system cost. Microprocessor RAM is a system RAM for the controller to utilize while executing commands and memory card management.

The high-speed bus and memory card control interface 20 further comprises a USB circuit and interface. The USB circuit and interface comprises a FIFO that operates directly with a controller buffer. The USB circuit and interface receives the command and parameter packet from the host computer and stores the packet in a register defined by the controller. When the host sends a command to this circuit, an interrupt is generated to the microprocessor to notify the microprocessor that a command has been received.

The high-speed bus and memory card control interface 20 further comprises a memory card switching circuit for managing data and command flow to the memory cards. This circuit is flexible and can be controlled by the microprocessor. If, for example, the host reads from or writes to a compactflash card, the microprocessor will switch this circuit to the compactflash interface. If, for example, the host reads from or writes to a smart media card, the microprocessor will switch this circuit to the smart media interface. This circuit interface is capable of controlling numerous interfaces such as PCMCIA Interface, IDE Interface, CFA Interface, Smart Media/SSFDC Interface, Secure Digital Interface, Multimedia Interface, and Memory Stick Interface.

A system buffer is provided to act as a buffer between the USB interface and the multiple memory card interface. It is also the FIFO of the USB protocol and the FIFO directly maps to this buffer. The microprocessor manages the address of this buffer. This buffer can be byte or word access. A hardware state machine creates the Read/Write timing to this buffer.

An ECC circuit encodes the ECC code while data is written to the memory card from the buffer cache. This circuit decodes the ECC code while data is read from the memory card. When an ECC error occurs, this circuit will find out the error word/byte address in the buffer cache and correct it. A CRC circuit is provided to detect errors while data is transferred from or to a memory card.

When the host writes the read ID table command to the USB controller, the controller will read the ID table from the card and transfer it to the USB host. For memory cards that do not contain an ID table inside the card, the USB controller will create a table according to the specification for each card.

The host computer reads the card number via the USB interface utilizing the USB protocol and commands.

Controller firmware fixes the memory card type and the number, for example: 1^{st} drive: CompactFlash Card, 2^{nd} drive: Smart Media Card, 3^{rd} drive: SDIMMC card, 4^{th} drive: Memory Stick, etc.

When the host computer (not shown) reads from or writes to the card through the device driver, it will also send the card number to read the card, for example, if it wants to read the compactflash card, it will send the card number “1”.

Indicators 35, such as LED's, are provided to indicate when a card is being accessed.

A mass storage interface 40 is provided for interfacing with other types of storage devices such as IDE, etc.

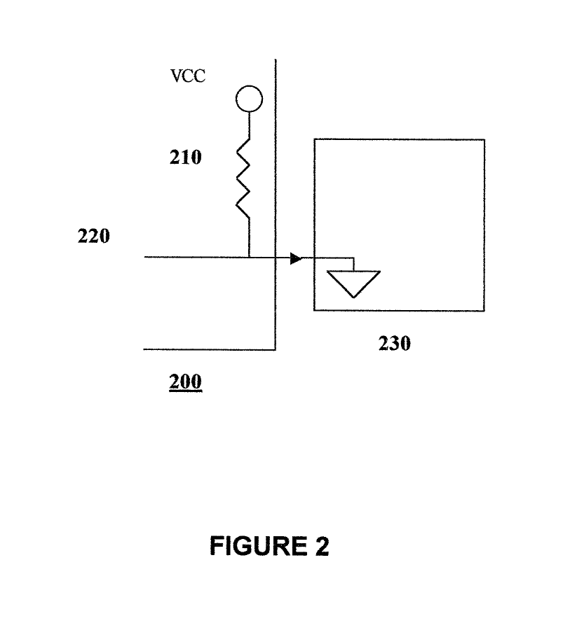

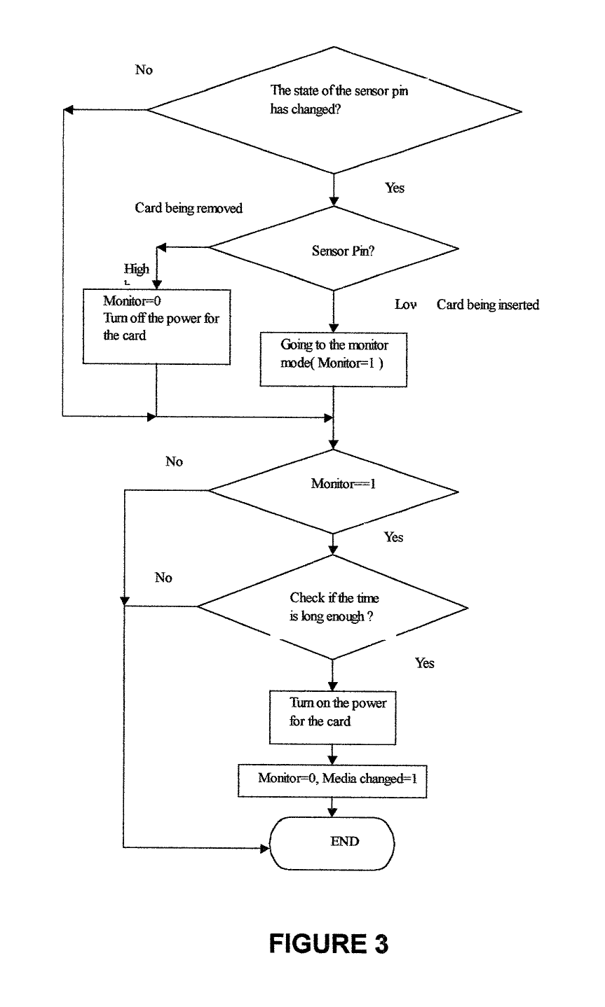

Refer to FIG. 2, which is a diagram of the card sensor circuitry of the multi-card adapter according to an embodiment of the present invention. Also, refer to FIG. 3, which is a flowchart of the card detecting method of the multi-card adapter according to an embodiment of the present invention.

When no card is inserted into the connector or socket, the sensor pin 220 will remain high because of the pull high resistor 210. When a card 230 is inserted, because the corresponding pin on the card 230 is connected to the ground, the sensor pin 220 will be low. Then the multiple memory card adapter 200 will know there is a card 230 inserted. When the card 230 is removed, the sensor pin 220 will go high again. Then the multiple memory card adapter 200 will know the card 230 has been removed. To avoid problems generated by bouncing effects, a timer is used to monitor the state of the sensor pin 220. The multiple memory card adapter 200 will recognize that a card 230 is inserted only if the state of the sensor pin 220 remains low for a certain time period.

The multiple memory card adapter of the present invention has the advantage of uses one controller to manage all of the memory cards. This reduces production costs, manufacturing time, maintenance, repair and reduces the size of the adapter.

There are numerous memory card types and standards and users can have several different types of memory cards, but the multiple memory card adapter of the present invention supports the different interfaces. Therefore only one adapter is required in order to use memory cards of different types and standards.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A multiple memory card adapter comprising:
an interface for connecting a memory card to the multiple memory card adapter; and
a cable with connector for connecting the multiple memory card adapter to a host computer.

2. The multiple memory card adapter of claim 1, wherein the cable is a universal serial bus cable.

3. The multiple memory card adapter of claim 1, wherein the cable is a firewire cable.

4. The multiple memory card adapter of claim 1, wherein the memory card is a compact flash memory card.

5. The multiple memory card adapter of claim 1, wherein the memory card is a memory stick.

6. The multiple memory card adapter of claim 1, wherein the memory card is an mmc memory card.

7. The multiple memory card adapter of claim 1, wherein the memory card is a smart media memory card.

8. The multiple memory card adapter of claim 1, wherein the memory card is a micro drive.

9. The multiple memory card adapter of claim 1, wherein the memory card is a secure digital memory card.

10. A multiple memory card adapter comprising:
a plurality of interfaces for connecting memory cards to the multiple memory card adapter, wherein the plurality of interfaces comprises at least two different type of memory card interfaces; and
a cable with connector for connecting the multiple memory card adapter to a host computer.

11. The multiple memory card adapter of claim 10, wherein the cable is a universal serial bus cable.

12. The multiple memory card adapter of claim 10, wherein the cable is a firewire cable.

13. The multiple memory card adapter of claim 10, wherein the memory card is a compact flash memory card.

14. The multiple memory card adapter of claim 10, wherein the memory card is a memory stick.

15. The multiple memory card adapter of claim 10, wherein the memory card is an mmc memory card.

16. The multiple memory card adapter of claim 10, wherein the memory card is a smart media memory card.

17. The multiple memory card adapter of claim 10, wherein the memory card is a micro drive.

18. The multiple memory card adapter of claim 10, wherein the memory card is a secure digital memory card.

19. A multiple memory card adapter comprising:
A compact flash memory card interface for connecting a compact flash memory card to the multiple memory card adapter;
A smart media card interface for connecting a smart media memory card to the multiple memory card adapter;
A micro drive interface for connecting a micro drive memory card to the multiple memory card adapter;
A secure digital interface for connecting a secure digital memory card to the multiple memory card adapter;
A memory stick interface for connecting a memory stick to the multiple memory card adapter; and
A universal serial bus cable with connector for connecting the multiple memory card adapter to a host computer.
